(19) United States
(12) Patent Application Publication
(10) Pub. No.: US 2025/0355090 A1
(43) Pub. Date: Nov. 20, 2025

(54) LINEAR AND NONLINEAR METALENS INTEGRATED WITH TETRALATERAL DETECTOR

(71) Applicant: GPD Optoelectronics Corp., Salem, NH (US)

(72) Inventors: David T. Beatson, Plymouth, MI (US); Peter E. Dixon, Bedford, NH (US)

(73) Assignee: GPD Optoelectronics Corp., Salem, NH (US)

(21) Appl. No.: 19/206,208

(22) Filed: May 13, 2025

Related U.S. Application Data
(60) Provisional application No. 63/647,114, filed on May 14, 2024.

(51) Int. Cl. G01S 7/481; G02B 1/00

(52) U.S. Cl. CPC G01S 7/4816; G02B 1/002

(57) ABSTRACT

An optical detector system providing electrical output signals. The system includes an apertured surface and a transparent window, with a metasurface on the window's opposite side. The metasurface imparts spatially varying phase delay and/or amplitude or polarization modulation to deflect ILR based on their angle of incidence, producing exiting light rays. These rays are detected by a two-dimensional tetralateral position-sensing detector (TLD) with a single resistive photo-absorption layer and four electrodes. The TLD generates X-Y position signals proportional to the azimuth and elevation of the incoming ILR. A computer may be included to calculate these angular values from the position signals.

### RELATED APPLICATION

This application claims the benefit of priority to U.S. Provisional Patent Application Ser. No. 63/647,114, filed on May 14, 2024, the contents of which are incorporated in this application by reference.

### TECHNICAL FIELD

The present disclosure relates generally to optoelectronic devices and, more particularly, to an optical detector system for receiving incident light and transmitting signals indicative of the characteristics of the light, including incident beam azimuth and elevation angle and beam power to device.

### BACKGROUND OF THE DISCLOSURE

As explained in an article by R. Paschotta titled “Position-Sensitive Detectors,” available at https://www.rp-photonics.com/position_sensitive_detectors.html and accessed on May 16, 2023, position-sensitive detectors are photodetectors with which one can measure the position of a light spot (or, as disclosed in U.S. Pat. No. 11,424,827 titled “Optical Tracking System,” a non-spot impingement on the photodetector, such as those impingements illustrated in FIG. 9 of the patent, created by a non-spot beam shape) in one or two dimensions, normally with a relatively high speed. The light spot is usually caused by a laser beam hitting the photodetector. Such photodetectors can be used to monitor beam position and, therefore, optical system alignment (laser spot trackers); and (within a feedback system) to stabilize the position of a laser beam (auto aligners). Another application is to measure distances by triangulation.

Position-sensitive detectors can be based on different operation principles. One measurement principle for position sensing is to use a kind of segmented photodetector, which can measure optical intensities for a few or even many different spatial positions (pixels). From the resulting data, the position of the light spot can be calculated. The uniformity of response between different detector segments is of course an important quality feature of such devices.

In the simplest case, as illustrated in FIG. 1, a photodiode 10 with two active segments, sections, or detectors 12 and 14 (a dual-segment photodiode or dual-cell photodiode) is used, with a narrow gap 16 between them. The incident beam forms a light spot 18 on the photodiode 10. The beam radius of the incident beam is chosen such that at least for beam positions in the intermediate range both detectors 12, 14 obtain some optical power. FIG. 2 is a graph depicting the output signals from the photodiode 10 with two signals as functions of the beam position. From the relative signals related to the two detectors 12, 14 the beam position can be calculated. The gap 16 between the adjacent detectors 12, 14 is a transition region. The device design ultimately determines whether charge can be collected from light incident upon the transition zone (“gap”), where charge may be shared across multiple devices, or there may be a reduction in signal, or changed optical performance. Thus, the segmented device may result in perturbations or may result in “blind spots” or areas in which no output signal is produced by incident light.

Note that for this kind of device one obtains a nonlinear dependence of the signal on the position; therefore, a linearization technique may have to be applied. In addition, the relative intensities depend not only on the beam position, but also on the beam radius. For those reasons, such segmented diodes are not ideally suited for quantitative position measurements. They are useful, however, for checking whether a beam is properly centered (centering indicators), e.g., within a feedback system for automatic alignment. For example, such devices are used in devices for optical data storage (CD-ROM, DVD, etc.).

Similarly, one can use a quadrant photodiode 20 with four active segments, sections, or detectors 22, 24, 26, and 28 having a narrow gap 30 between them as shown in FIG. 3. The incident beam forms a light spot 18 on the quadrant photodiode 20. The quadrant photodiode 20 can be used to monitor positions in two dimensions. For further information about the quadrant photodiode 20, see D. Marett, “A Four Quadrant Photo Detector for Measuring Laser Pointing Stability,” available at https://www.conspiracyoflight.com (2012).

Segmented photodiodes like the photodiode 10 and the quadrant photodiode 20 are often based on silicon PIN technology, with sensitivity in the visible spectral range and up to about 1 μm. (They are also available with other semiconductors, however, such as indium gallium arsenide (InGaAs) for detection at longer infrared wavelengths.) The quadrant photodiode 20 often consists of four separate P on N silicon photosensitive surfaces separated by the small gap 30. In one example, the gap 30 is commercially available between 10 μm and 50 μm. The laser beam is usually pointed towards the dead center among the four quadrants and the beam diameter is selected to fit inside of the total quadrant area. Although light may fall on all four quadrants, the difference between the left and right quadrants (X output) and the top and bottom quadrants (Y output) can be adjusted to zero by centering the beam, whereas the SUM is at a maximum. The device X and Y output voltages thereby become very sensitive to slight deviations in the position of the beam from this initial centered setting. On the other hand, the SUM value can be used to measure changes in the beam intensity, so this can be used to correct the X and Y output values for voltage changes that are due to intensity fluctuations rather than actual beam deviations. In order to present the outputs of the four quadrants as X, Y, and SUM, it is necessary to first amplify the individual quadrant outputs, and then combine them using a series of sum and difference amplifiers (for X and Y) or just a sum amplifier (for the SUM output). Further, the spot size and location determine whether a signal can be collected from more than one pixel element. If in some instances light is fully within one single pixel, with no light incident upon a gap or another pixel, this can cause ambiguity as to spot location, causing the system to raster, slew, or “search” for the precise location of the beam.

As illustrated in FIG. 4, the PIN diode 40 that forms the basis for segmented photodiodes like the photodiode 10 and the quadrant photodiode 20 is an alteration of the PN-junction diode having an area A. Unlike the PN-junction diode, the PIN diode 40 has an undoped, wide intrinsic semiconductor region 44 (with a width W) between a P-type semiconductor region 42 and an N-type semiconductor region 46. Thus, the PIN diode 40 has three regions: namely, the P-region 42, the I-region 44, and the N-region 46. The P and N regions 42, 46 are normally heavily doped because they are used for Ohmic contacts. The inclusion of the intrinsic region 44 in the PIN diode 40 can significantly increase the breakdown voltage for the application of high voltage. The intrinsic region 44 also offers advantageous properties when the PIN diode 40 operates at high frequencies in the range of radio waves and microwaves.

The working principle of the PIN diode 40 is exactly the same as the PN-junction diode. The main difference is that the depletion region, which normally exists between the P and N regions 42, 46, is larger. In any PN-junction diode, the P region 42 has been doped to contain holes. Likewise, the N-region 46 has been doped to have excess electrons. The intrinsic region 44 between the P and N regions 42, 46 includes no charge carriers because any electrons or holes merge. Therefore, the depletion region functions as an insulator. FIG. 5 outlines the structure of the PIN diode 40. One application of the PIN diode 40 is use as a photodetector to convert light (optical signals) into current (electrical signals).

Segmented photodiodes are also known having more complex arrays than the two active segments, sections, or detectors of the photodiode 10 and the four active segments, sections, or detectors of the quadrant photodiode 20. There are photodiode arrays containing a larger number of photodiode segments either in a linear array for one-dimensional position sensing or on a two-dimensional grid. Such devices can contain hundreds or thousands of diodes. In principle, one could derive the spot position simply by taking the coordinates of the pixel (detector segment) receiving the highest optical power. The spatial resolution would then be identical to the pixel spacing. A much better resolution can be achieved by using data from several pixels, assuming that the light spot 18 is large enough. For example, one may fit a calculated curve to the pixel data, calculating the position and the beam radius as fit parameters. A computationally simpler approach is to calculate the centroid via first moments of the intensity distribution, possibly after discarding pixels which have intensity values below a certain threshold value or are spatially too far away from the intensity maximum.

One example of segmented photodiodes having a more complex array is disclosed in FIG. 6, which illustrates a known InGaAs PIN double quadrant photodetector 50 having eight independent active-area sections, segments, or detectors. The double quadrant photodetector 50 is available from Princeton Lightwave, Inc. of Cranbury, New Jersey and GPD Optoelectronics of Salem, NH. As illustrated, the eight-section double quadrant photodetector 50 has four inner quadrant sections 52 and four outer quadrant sections 54. Typically the quadrant photodetectors will be backed in hermetically or near hermetically sealed packaging for the double quadrant photodetector 50 is a T0-8 through-hole metal can with an anti-reflection coated window cap (not shown) and twelve pins, terminals, or leads 56. Eight leads 56 connect the sections 52, 54 of the inner and outer quadrants of the double quadrant photodetector 50 to respective bond pads 58, and the remaining four leads are connected to the common cathode (substrate) of the detectors. (Neither the remaining four leads nor the cathode are shown in FIG. 6.) All twelve leads are isolated from the package case. The common cathode connection is made to each center pin of each of the four groups of three in-line pins. The overall detector optically active diameter, D, is typically 1 mm.

Another example of segmented photodiodes having a more complex array is disclosed in U.S. Pat. No. 3,689,772 titled “Photodetector Light Pattern Detector.” The array includes first and second semi-circular sub-arrays. The first sub-array has a plurality (i.e., eight) of concentric annular detectors, such as hemi-rings. The second sub-array has a plurality (i.e., thirty four) of detectors extending approximately radially from near to the center of the first sub-array. Each detector of the array is provided with a separate attached electrical conductor. The conductors attached to the ring detectors are positioned in portions of approximately radial sector gaps separating the two sub-arrays.

Yet another example of segmented photodiodes having a more complex array is disclosed in U.S. Pat. No. 11,646,384 titled “Optoelectronic Devices With Non-Rectangular Die Shapes.” FIG. 6 of the patent is a top plan view illustration of multiple photodiodes within a detector assembly. More specifically, the photodiodes may be non-rectangular shaped, such as a trapezoid, and can be further arranged in configurations that increase surface area use.

Despite these attempts, a need exists for an optical detector system that realizes nonlinear optical performance, very similar to human vision, with lower resolution in the periphery and high resolution in near frontal illumination. Therefore, an object of the present disclosure is to provide such an optical detector system. Another object is to provide an optical detector system that transforms an impinging light source (preferable a laser beam) from both an azimuth and elevation angle within a hemisphere to a linear (or nonlinear) X-Y coordinate. Yet another object is to allow for high sensitivity, high resolution, and high sample acquisition rates during operation of an optical detector system. A further object is to provide an optical detector system configured to be included in a compact electro-optic package that is considerably smaller and has a lower cost than the current hemispherical lens on a focal plane array. Finally, an object of the present disclosure is to provide an optical detector system that achieves higher response uniformity, faster response times, much lower dark current, easier bias application, and lower fabrication cost as compared to conventional systems.

### SUMMARY OF THE DISCLOSURE

To meet this and other needs, to achieve these and other objects, and in view of its purposes, the present disclosure provides an optical detector system. The optical detector system includes an apertured surface having an aperture through which pass incident light rays having different angles of incidence. The optical detector system also includes a transparent window having a first side to which the apertured surface is affixed and an opposite side, the incident light rays passing through the window. A metasurface is disposed on the opposite side of the window and has nanometer-scale structures patterned on the window to impart spatially varying optical phase delay and/or amplitude modulation onto the incident light rays. The metasurface turns each incident light ray a different amount depending upon the angle of incidence of the incident light ray and creates exiting light rays. This type of meta lens is commercially available as prototypes from 2Pi Optics Inc., Cambridge, MA. The optical detector system further includes a two-dimensional tetralateral position sensing detector having a single resistive layer and four separate electrodes, the tetralateral position sensing detector receiving the exiting light rays from the metasurface and generating an X-Y position signal. The optical detector system also may include a computer configured to determine, based on the X-Y position signal generated by the tetralateral position sensing detector, corresponding azimuth and elevation angles of the incident light rays.

An important aspect of the optical detector system is integration of a hemispherical meta structured lens (i.e., a flat lens) into package containing a tetralateral sensor with the appropriate space between the lens and the tetralateral or lateral photodetector. This metalens and aperture can be the window on a package incorporating a tetralateral sensor or the metalens can be patterned on to the backside of the substrate carrying a tetralateral detector. The very compact electro-optic package is considerably smaller and has a lower cost than the current hemispherical lens on a focal plane array or tetralateral detector. A meta optical lens can be designed to create a nonlinear optical performance very similar to human vision, with low resolution in the periphery and high resolution in near frontal illumination. The optical detector system enables a very compact electro-optical package capable of transforming an impinging light source (preferable a laser beam) from both an azimuth and elevation angle within a hemisphere to a linear (or nonlinear) X-Y coordinate on the tetralateral photodetector whereas the associated voltages of the four electrodes on the tetralateral photodetector can be post-processed into a hemispherical impinging light vector and light intensity for identification of laser source location within a hemisphere.

Still further provided are a related system and at least one computer-readable non-transitory storage media embodying software. The one or more computer-readable non-transitory storage media embodying software is operable when executed, in one embodiment, to perform a series of steps using the optical detector system including the metalens and the tetralateral position sensing detector.

It is to be understood that both the foregoing general description and the following detailed description are exemplary, but are not restrictive, of the disclosure.

### 1. BRIEF DESCRIPTION OF THE DRAWING

The disclosure is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 illustrates a conventional dual-segment photodiode with a light spot of a beam impinging on the photodiode;

FIG. 2 is a graph depicting the output signals from the photodiode illustrated in FIG. 1 with two signals as functions of the beam position;

FIG. 3 illustrates a conventional quadrant photodiode with a light spot impinging on the quadrant photodiode;

FIG. 4 provides an outline of a PIN diode;

FIG. 5 illustrates the structure of a PIN diode;

FIG. 6 illustrates a known InGaAs PIN quadrant photodetector having eight independent active-area sections, segments, or detectors;

FIG. 7 illustrates an equivalent circuit for a single-element photodiode;

FIG. 8 illustrates an equivalent circuit for a one-dimensional position sensing device;

FIG. 9 is a side view illustrating one embodiment of an optical detector system according to the present disclosure;

FIG. 9A is a top view of the embodiment of the optical detector system shown in FIG. 9;

FIG. 10 illustrates how the photoelectric effect drives current in a tetralateral PSD sensing a single axis;

FIG. 11 illustrates a 2D tetralateral PSD which is capable of providing continuous position measurement of an incident light spot generated from incident light in two dimensions;

FIG. 12 is a side view of another embodiment of the optical detector system according to the present disclosure including a back-illuminated 2D tetralateral PSD;

FIG. 12A is a top view of the embodiment of the optical detector system shown in FIG. 12;

FIG. 13 illustrates one embodiment of the metastructure included in the optical detector system shown in FIGS. 9, 9A, 12, and 12A;

FIG. 14 illustrates one embodiment of a hemispherical metalens including a metasurface according to the present disclosure;

FIG. 15 is a graph illustrating both a linear and a nonlinear relationship between the AOI of incident light rays and the radial axis position of the rays that form a light spot on the 2D tetralateral PSD;

FIG. 15A is a graph illustrating a square root function;

FIG. 15B is a graph illustrating a cube root function;

FIG. 15C is a graph illustrating a hyperbolic tangent function;

FIG. 16A is a top view of a test configuration used for analysis and optimization of the optical detector system according to the present disclosure;

FIG. 16B is a side view of the test configuration shown in FIG. 16A;

FIG. 17 illustrates the optical detector system according to the present disclosure as tested using the test configuration;

FIG. 18A is a graph of the photo-response in volts of the 2D tetralateral PSD of the optical detector system shown in FIG. 17 against the angle of the 2D tetralateral PSD in degrees, reflecting raw data;

FIG. 18B is a graph corresponding to the graph of FIG. 18A reflecting scaled data;

FIG. 18C is a graph of the photo-response in volts of the 2D tetralateral PSD of the optical detector system shown in FIG. 17 against the angle of the 2D tetralateral PSD in degrees, reflecting additional raw data;

FIG. 18D is a graph corresponding to the graph of FIG. 18C reflecting scaled data;

FIG. 19 shows the 2D tetralateral PSD under test in which the power of the incident light through the aperture of the optical detector system is about 10 mW;

FIGS. 20A and 20B are graphs of the scaled photo-response in volts (V_{Channel}/V_{Sum}) of the 2D tetralateral PSD against the angle of the 2D tetralateral PSD in degrees, reflecting scaled data, along the “A” scan of FIG. 19;

FIGS. 20C and 20D are graphs of the scaled photo-response in volts (V_{Channel}/V_{Sum}) of the 2D tetralateral PSD against the angle of the 2D tetralateral PSD in degrees, reflecting scaled data, along the “B” scan of FIG. 19;

FIG. 21A is a graph of the scaled photo-response in volts (V_{Channel}/V_{Sum}) of the 2D tetralateral PSD against the angle of the 2D tetralateral PSD in degrees, reflecting scaled data, at a power of about 570 μW;

FIG. 21B is a graph of the scaled photo-response in volts (V_{Channel}/V_{Sum}) of the 2D tetralateral PSD against the angle of the 2D tetralateral PSD in degrees, reflecting scaled data, at a power of about 10 mW; and

FIG. 22 illustrates an example computer system for use in connection with the optical detector system according to the present disclosure.

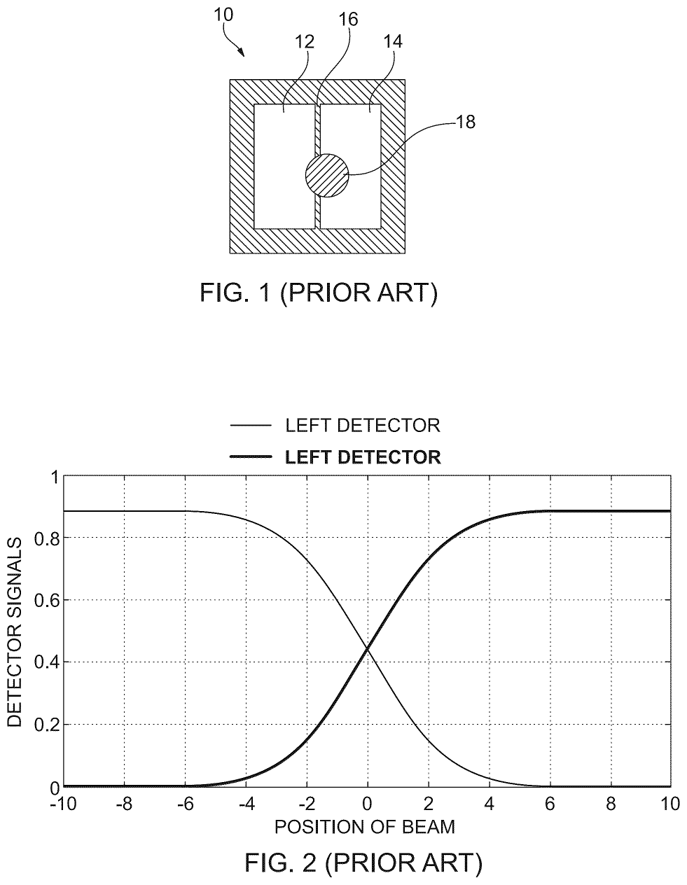

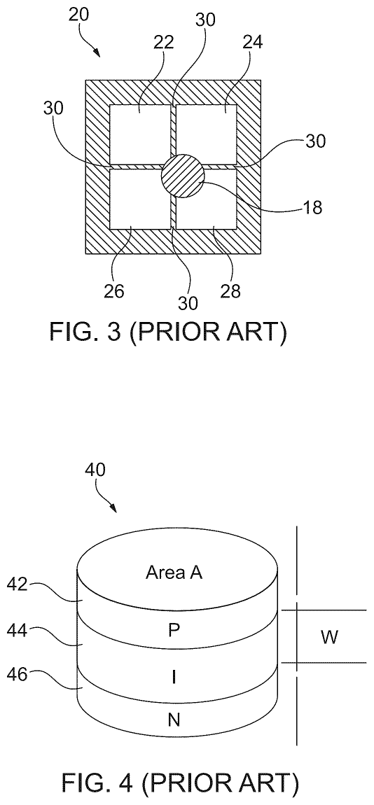

### DETAILED DESCRIPTION OF THE DISCLOSURE

In this specification and in the claims that follow, reference will be made to a number of terms which shall be defined to have the following meanings ascribed to them. The term “substantially,” as used in this document, is a descriptive term that denotes approximation and means “considerable in extent” or “largely but not wholly that which is specified” and is intended to avoid a strict numerical boundary to the specified parameter. Directional terms as used in this disclosure—for example up, down, right, left, front, back, top, bottom—are made only with reference to the figures as drawn and are not intended to imply absolute orientation.

The term “about” means those amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When a value is described to be about or about equal to a certain number, the value is within ±10% of the number. For example, a value that is about 10 refers to a value between 9 and 11, inclusive. When the term “about” is used in describing a value or an end-point of a range, the disclosure should be understood to include the specific value or end-point. Whether or not a numerical value or end-point of a range in the specification recites “about,” the numerical value or end-point of a range is intended to include two embodiments: one modified by “about” and one not modified by “about.” It will be further understood that the end-points of each of the ranges are significant both in relation to the other end-point and independently of the other end-point.

The term “about” further references all terms in the range unless otherwise stated. For example, about 1, 2, or 3 is equivalent to about 1, about 2, or about 3, and further comprises from about 1-3, from about 1-2, and from about 2-3. Specific and preferred values disclosed for components and steps, and ranges thereof, are for illustration only; they do not exclude other defined values or other values within defined ranges. The components and method steps of the disclosure include those having any value or any combination of the values, specific values, more specific values, and preferred values described.

The indefinite article “a” or “an” and its corresponding definite article “the” as used in this disclosure means at least one, or one or more, unless specified otherwise. “Include,” “includes,” “including,” “have,” “has,” “having,” comprise,” “comprises,” “comprising,” or like terms mean encompassing but not limited to, that is, inclusive and not exclusive.

The ability to transmit data wirelessly provides tremendous utility. Wireless transmission uses one or more frequencies of electromagnetic signals, such as optical wavelengths, to send information. Optical wavelengths may include, but are not limited to, infrared wavelengths, visible light wavelengths, ultraviolet wavelengths, and so forth. Optical wavelengths may move from one location to another in free space, including the atmosphere, a vacuum, and so forth.

A free space optical communication system may be used in a variety of different situations. For example, optical transceivers (include both a transmitter to send and a receiver to receive signals at optical wavelengths) may be used to provide an intersatellite link between a first satellite and a second satellite, allowing data to be sent from the first satellite to another. In another example, a ground station may communicate with a satellite using an optical transceiver. In still another example, fixed terrestrial stations may communicate with one another using optical transceivers. As with any system using electromagnetic signals, including optical wavelengths, the desired communication requires that the received signal must be received.

To maintain communication, it is necessary for the transmitter and the receiver to be pointed at one another and to maintain that pointing. The transmitter is positioned so that light from the transmitter is directed towards the receiver. Likewise, the receiver is positioned so that the light from the transmitter is received. For example, the light source that is transmitting needs to radiate light in the direction of the receiver, and the receiver needs to gather that light and process it with a detector.

In the ideal situation in which the transmitter and the receiver are not in motion and neither is subject to any sort of vibration or other disturbance, maintaining such careful pointing could be done once and never repeated. Unfortunately, all structures have some mechanical motion or vibration. These motions can result in a failure of the receiver to remain properly pointed at the transmitter and of the beam from the transmitter to remain properly pointed at the receiver. A device that is in motion and using optical communication, such as a satellite in orbit, introduces further complications. To account for these motions, some form of active adjustment or feedback may be used.

The active adjustment may include an optical detector system that provides output about how far a beam of incoming light deviates from a specified reference. The output signal(s) from the optical detector system may then be used to operate actuators affixed to an optical element. A feedback loop attempts to keep the incoming light aligned to a particular predetermined point, such as the center of a detector array, by using the output to operate the actuators. For example, the detector array may comprise photodetectors with each photodetector generating an output signal as light impinges on the individual photodetector.

Optical detector systems use an incoming beam with a beam shape that is typically (although not necessarily) circular in cross section, presenting a circular pattern (or “spot”) of light on the detector array. (A non-spot beam shape is a beam shape, where it impinges upon the detector array, that is non-circular in cross section.) The combined characteristics of the detector array and spot produce information about how much the output of the detector array changes in response to a change in the position of the light incident on the detector array. For example, the information describes how amplitude of an output signal from the photodetectors in the array changes as the spot moves across the detector array.

The accuracy of the information is affected by several factors. One factor is how much of the incoming beam of light that impinges on the detector array produces output. The portion of the beam that impinges on photodetectors in the array produces output. The portion of light that impinges on gaps between or among the photodetectors does not. For example, if the spot of light falls entirely within a gap between photodetectors, no output is produced.

The optical detector system provides output that is indicative of a relative position of an incoming beam of light relative to the detector array as well as distance of the incoming beam of light relative to the detector array. This output may then be used to operate one or more devices to provide active tracking of a beam of incoming light. The system may be used in a variety of applications including, but not limited to, intersatellite communications, communications between a satellite and ground station, communications between a satellite and user terminals, between vehicles, between terrestrial stations, and the like. For example, the system may be used in terrestrial applications, mobile applications, and so forth. Some of the applications are described in U.S. Pat. No. 11,424,827, mentioned above, which is incorporated by reference in this document.

A position-sensing device (PSD) is a photosensor (photodiode or phototransistor) which can identify the position where incident light strikes the sensing surface. There are uniaxial sensors which are only able to identify position along a single axis, and duolateral or tetralateral sensors which are able to identify position along two axes. All of these sensors provide currents on the output leads which are proportional to the overall intensity of light striking the sensing surface as well as to the distance between the output terminal and the location where the light struck the sensor. The sensors act as current sources, because the photoelectric effect dislodges electrons, which drives a current, so more light produces more current. The distance from the output terminal to the incident point is proportional to the resistance that the current experiences, resulting in different currents at different distances.

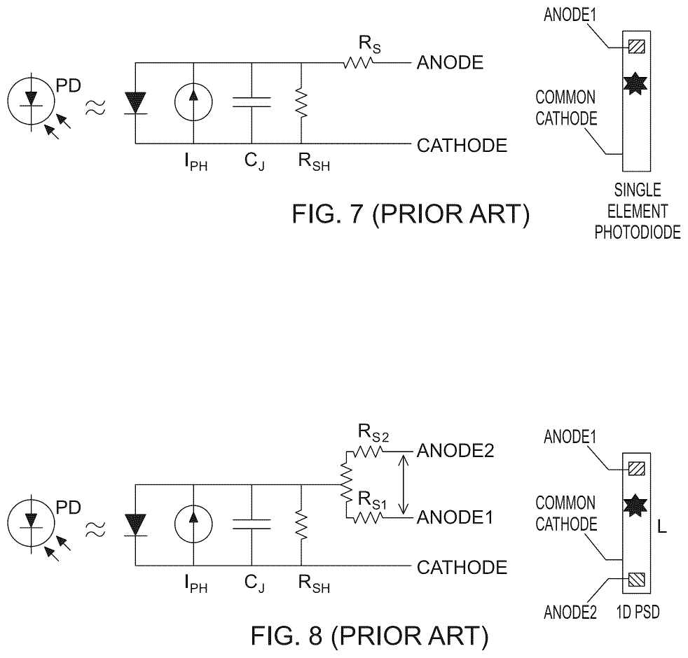

Conventional optical detector systems use a single element as discussed above. FIG. 7 illustrates an equivalent circuit for a single-element photodiode (PD). The single-element PD has two terminals: a single, discrete anode located on one surface of the PD (on which an illuminated spot impinges) and a common cathode that extends substantially along the entire opposite surface of the PD. The single-element PD is position ambiguous.

FIG. 8 illustrates an equivalent circuit for a one-dimensional position sensing device (1D PSD). The 1D PSD has three terminals: two, discrete anodes located on one surface of the 1D PSD (on which an illuminated spot impinges) and a common cathode that extends substantially along the entire opposite surface of the 1D PSD. Both anodes reference the same cathode. The 1D PSD is able to provide positional data in a single axis, typically within a single pixel. For a photonic 1D PSD, the position is relative to the location of the illuminated spot. The longitudinal position X is measured by the ratio I₁: I₂, where I₁ is the current in Anode 1 and I₂ is the current in Anode 2. More specifically, if L is the distance between the two anodes, the applicable formula is: (I₂−I₁)/(I₂+I₁)=2X/L.

### A. The Optical Detector System

Several embodiments of the optical detector system 100 are disclosed in this document.

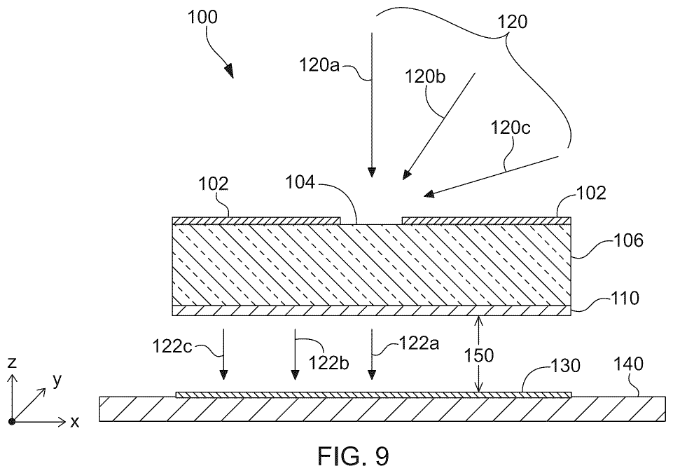

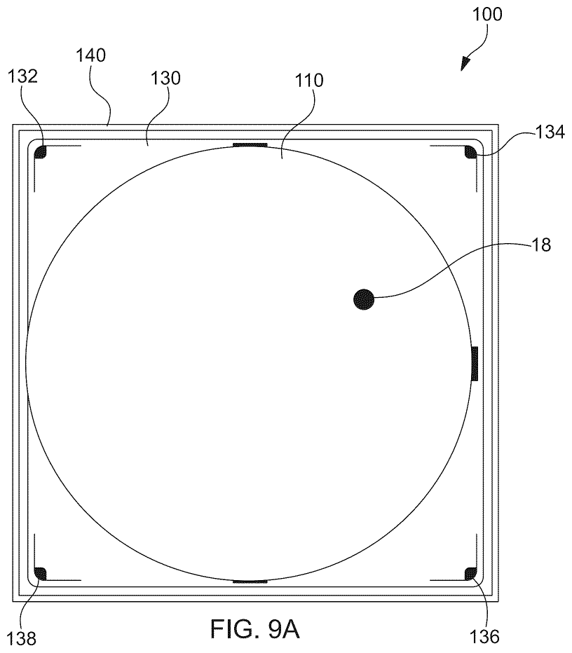

One embodiment of the optical detector system 100 according to the present disclosure is illustrated in FIG. 9, which is a side view illustrating the components of the system 100 with reference to a Cartesian coordinate system (X, Y, Z). A Cartesian coordinate system is a coordinate system that specifies each point uniquely in three-dimensional space by three Cartesian numerical coordinates, which are the signed distances to the point from three, fixed, mutually perpendicular directed lines, measured in the same unit of length. Each reference line is called a coordinate axis or just an axis of the system, and the point where they meet is its origin, usually at ordered triplet (0, 0, 0). The coordinates can also be defined as the positions of the perpendicular projections of the point onto the three axes, expressed as signed distances from the origin.

The system 100 includes an apertured surface 102 having an aperture 104. The size of the aperture 104 should be as small as possible; a design tradeoff exists between the size of the aperture 104 and the noise created in the PSD of the system 100. The apertured surface 102 may be formed from an opaque material which is patterned to form the aperture 104. This can be accomplished by defining the aperture 104 in an opaque layer, e.g., metal or black ink, using e.g., lithography or printing methods, as well as by assembling a separate opaque layer, window, or light baffle containing the aperture 104.

The apertured surface 102 is affixed to one side of a transparent window 106 typically made of glass. To the opposite side of the transparent window 106 is affixed a thin, flat optics layer 110. The apertured surface 102 and the optics layer 110 can be affixed (e.g., bonded) onto the transparent window 106 via optical adhesives.

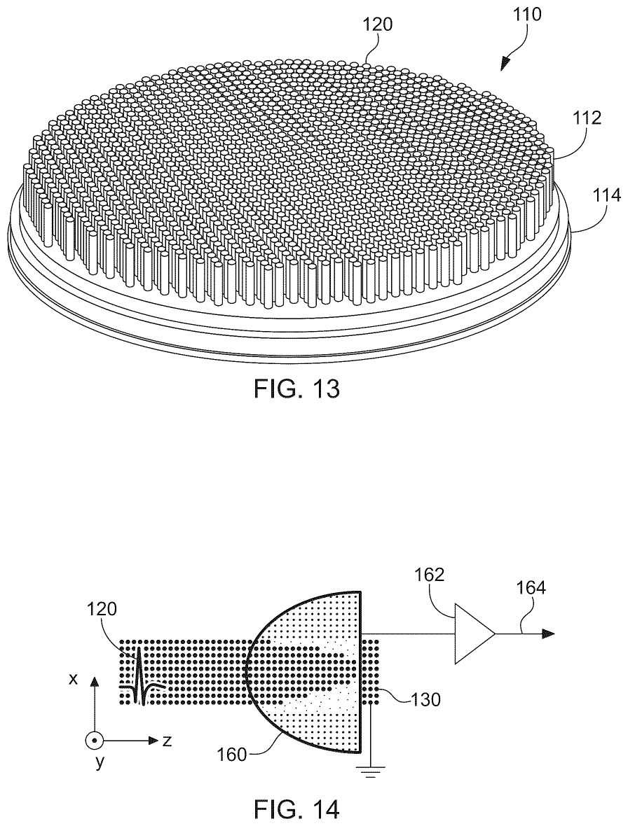

Preferably, the thin, flat optics layer 110 is a metasurface as shown in FIG. 13. A metasurface is defined as comprising sub-wavelength structures (i.e., meta optical structure) PLEASE REPLAVE ALL META-ATOM REFERENCES WITH MEAT OPTCOAL STRUCTURE 112 fabricated or assembled on a base 114 to impart spatially varying optical phase delay and/or amplitude or polarization modulation onto a wavefront of incident light 120. The meta optical structure 112 and the base 114 may be made of the same or different optical materials. The meta optical structure 112 is designed to change the phase, amplitude, and/or polarization of the incident light 120. The meta optical structure 112 may have the same or different geometries, dimensions, orientations, and/or pitches. Exemplary geometries may include rectangular, cylindrical, freeform, or any other suitable shapes or combinations of different shapes, etc. The pitch or lattice of the meta optical structure 112 may have any suitable shape and period (e.g., square, rectangular, or hexagonal). The lattice may also be aperiodic, with varying or random distances between adjacent meta optical structure 112. In some examples, the gap between adjacent meta optical structure 112 may be designed to have a constant gap distance. One or both sides of the base 114 may be flat or curved. Both the surface having the meta optical structure 112 and the base 114 may be rigid, flexible, or stretchable. The base 114 may also include a spacer (not shown).

The geometries, dimensions, and layout of the meta optical structure 112 and base 114 are designed to provide the target optical functions. The metasurface 110 may be designed to operate at a single wavelength, multiple wavelengths, or over a continuous spectral range. The metasurface 110 may be designed to provide different functions depending on the properties of the incident light 120 (e.g., polarization, wavelength, incident/exiting angle, intensity, etc.).

The metasurface 110 combined with the corresponding apertured surface 102 and window 106 form a wide field-of-view (FOV) metalens capable of high-resolution imaging across a FOV up to 180°. In its baseline form, the rays 120a, 120b, and 120c of the incident light 120 are transmitted through the aperture 104 and are focused or re-directed by the metasurface 110 (with or without an additional optical filter) onto a 2D tetralateral PSD 130 over a wide FOV. The tetralateral PSD 130 is mounted on a substrate 140, which acts as a mechanical support for the tetralateral PSD 130. The metasurface lens (or metalens) can be designed to operate at infrared wavelengths (e.g., 850 nm or 940 nm) such that it is invisible to the human eye, as well as other wavelengths (e.g., in the visible spectrum). It may also be designed for broadband operations. The system 100 is designed to receive incident light 120 that is monochromatic and emanates from a single source. Typically, the incident light will emanate from a laser.

The optional filter may be a spectral, angular, and/or polarization filter. The filter may be in the form of a multi-layer filter, cavity structures, diffractive optical elements, slanted gratings, or a metasurface that performs the above filtering function(s). An angular filter (e.g., some cavity structures, diffractive optical elements, or metasurfaces that exhibit angular selectivity) may be used to block or reduce stray light or form a self-limiting aperture depending on the incident or exiting angle of light. Polarization filters may also be useful in cases where the metalens is designed to be polarization sensitive. A metasurface may also serve as the filter.

One feature of the embodiment of the system 100 illustrated in FIG. 9 is that it allows angle-selective filtering of background ambient light to boost signal-to-noise ratio (SNR), which is not possible with conventional multilayer filters when applied to wide-field imaging. This is made possible by the (near-) telecentric configuration of the metalens, which means that light rays 120a, 120b, and 120c coming from different angles of incidence (AOIs) on the object side will leave the metalens only within its surface-normal (or near normal, e.g., within 20 degrees from normal) exit cone as corresponding exit light rays 122a, 122b, and 122c. (The AOI is the angle that a line such as a ray of light falling on a surface or interface makes with the normal drawn at the point of incidence.) In other words, at any AOI, the chief ray of the incident light 120 leaves the metasurface 110 at a direction normal (or near normal, e.g., within 20 degrees from normal) to the metasurface 110. Therefore, the tight distribution of light angles on the image side allows the use of a single bandpass filter to efficiently reject ambient background light from all AOIs. Meanwhile, meta optical structure 112 positioned at different locations of the metasurface 110 can be designed differently (e.g., according to the AOIs) to provide enhanced angularly or spatially dependent responses.

The tetralateral PSD 130 is located at a predetermined distance from the metasurface 110. By predetermined is meant determined beforehand, so that the predetermined characteristic must be determined, i.e., chosen or at least known, in advance of some event (in this case, manufacture of the system 100 for a particular application). As shown in FIG. 9, the predetermined distance defines a space 150 that exists between the metasurface 110 and the tetralateral PSD 130. The space 150 should be less than about 5 mm and is akin to a focal distance. Preferably, the space 150 is less than about 1 mm. Typically, the space 150 is between zero and about 1 mm.

Additional details about the 2D tetralateral PSD 130 and the metasurface 110 are provided below, in turn.

### B. The Tetralateral PSD

The tetralateral PSD 130 is a type of sensor used to accurately measure the displacement of a beam of incident light 120 relative to a calibrated center. Tetralateral PSDs typically have a silicon photodiode-based pincushion sensor that is insensitive to beam shape and power density. Unlike quadrant sensors that require overlap in all quadrants, tetralateral sensors provide positional information for any light spot 18 within the detector region, independent of beam shape, size, and power distribution. Such characteristics render tetralateral PSDs ideal for measuring the movement of a beam or the distance traveled; useful as feedback for alignment systems; and suitable for applications such as tool alignment, leveling measurements, angular measurements, 3D vision, and position measuring.

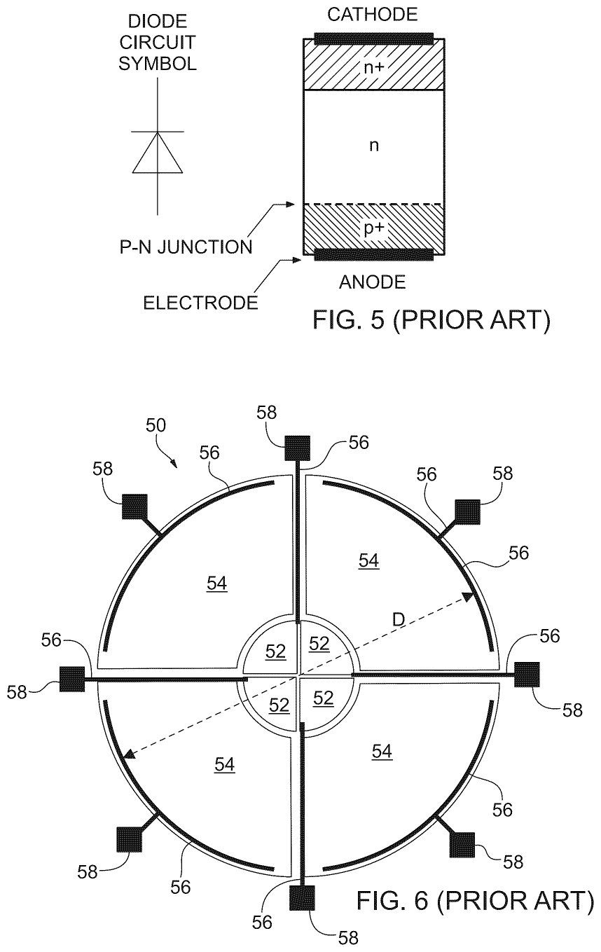

FIG. 9A is a top view of the system 100 shown in FIG. 9, highlighting the tetralateral PSD 130 positioned under the metasurface 110. The tetralateral PSD 130 consists of a single square PIN diode (see FIGS. 4 and 5) with a single resistive layer. The tetralateral PSD 130 has one common anode and four separate cathodes and, therefore, four separate electrodes 132, 134, 136, and 138. Each electrode is located proximate to one corner of the substantially square tetralateral PSD 130. Two electrodes are used for one-dimensional sensing; four electrodes, for two-dimensional sensing.

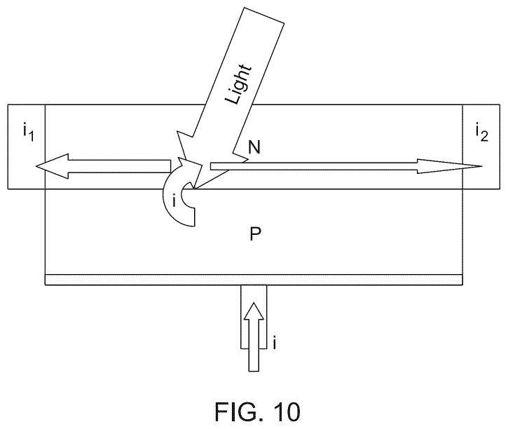

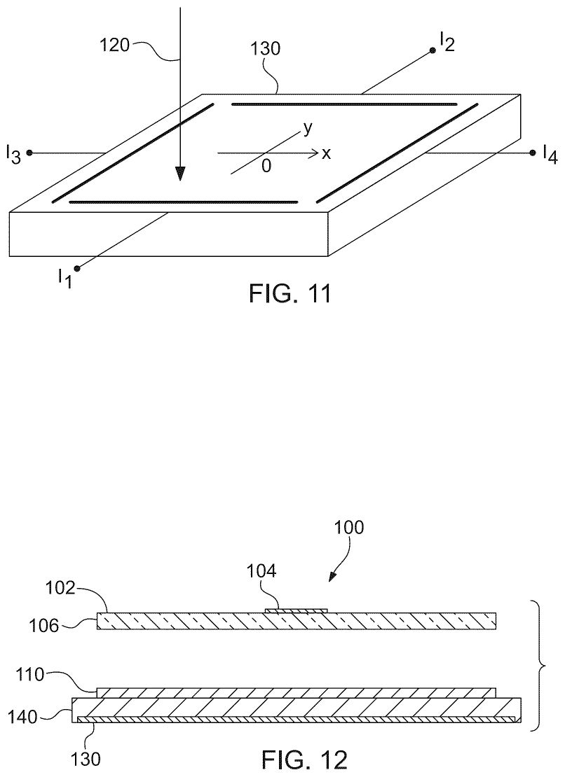

Photocurrent in the single resistive layer of the tetralateral PSD 130 is divided into two or four parts for one-or two-dimensional sensing and corresponding measurement capabilities, respectively. FIG. 10 illustrates how the photoelectric effect drives current in a tetralateral PSD sensing a single axis. FIG. 11 illustrates the 2D tetralateral PSD 130 which is capable of providing continuous position measurement of the incident light spot 18 generated from the incident light 120 in two dimensions (i.e., in the X-Y plane). When there is an incident light on the active area of the 2D tetralateral PSD 130, photocurrents I₁, I₂, I₃, and I₄ are generated and collected from the four electrodes 132, 134, 136, and 138 placed along each side of the square near the boundary. The incident light position can be estimated based on currents collected from the electrodes 132, 134, 136, and 138 as follows: X=kₓ×(I₄−I₃)/(I₄+I₃) and Y=k_{y}×(I₂−I₁)/(I₂+I₁). For the example illustrated in FIG. 9A, the electrode 134 is located nearest to the light spot 18 and, therefore, will generate the greatest current; the electrode 136 is located next nearest to the light spot 18 and, therefore, will generate the second greatest current; the electrode 132 is located next nearest to the light spot 18 and, therefore, will generate the third greatest current; and the electrode 138 is located farthest from the light spot 18 and, therefore, will generate the least current.

The 2D tetralateral PSD 130 has the advantages of higher response uniformity, faster response times, much lower dark current, easier bias application, and lower fabrication cost as compared to a focal plane array. The tetralateral PSD 130 functions best when used in applications where measurement is needed over a long or wide spatial range. Its measurement accuracy and resolution are independent of the shape and size of the light spot 18—unlike the quadrant detector which could be easily changed by air turbulence.

The 2D tetralateral PSD 130 does suffer, however, from a nonlinearity problem. Position nonlinearity is defined as the geometric variation between the actual position and the measured position of the incident light spot 18. Although the position estimate is approximately linear with respect to the real position when the light spot 18 is in the center area of the tetralateral PSD 130, over about two-thirds of the sensing area, the relationship becomes nonlinear when the light spot 18 is far away from the center. Thus, the tetralateral PSD 130 offers good position linearity at least over about two-thirds of the sensing area.

To reduce the nonlinearity of the tetralateral PSD 130, an adjusted set of equations has been proposed to estimate the incident light position. See Song Cui and Yeng Chai Soh, “Linearity indices and linearity improvement of 2-D tetralateral position sensitive detector,” IEEE Transactions on Electron Devices, vol. 57, No. 9, pp. 2310-16 (2010). These equations are: X=kₓ₁×(I₄−I₃)/(I₀−1.02(I₂−I₁))×(0.7(I₂+I₁)+I₀)/(I₀+1.02(I₂−I₁)) and Y=k_{y1}×(I₂−I₁)/(I₀−1.02(I₄−I₃))×(0.7(I₄+I₃)+I₀)/(I₀+1.02(I₄−I₃)). In these equations, I₀=I₁+I₂+I₃+I₄ and kₓ₁ and k_{y1} are scale factors.

The position estimation results obtained by this adjusted set of equations can be simulated. Assuming the light spot 18 is moving in steps in both directions, position estimates can be plotted on the two-dimensional plane. Thus, a regular grid pattern should be obtained if the estimated position is perfectly linear with the true position. The performance is much better using the adjusted equations than the previous equations. Detailed simulations and experiment results can be found in the paper by S. Cui.

The 2D tetralateral PSD 130 may be made of Indium Gallium Arsenide (InGaAs), Germanium (Ge), Silicon (Si), or another suitable material depending upon the intended application. The shunt resistance of an InGaAs detector is on the order of 10 MΩ; that of a Ge detector is on the order of kΩ, several orders of magnitude smaller. Thus, a Ge detector will exhibit a much higher level of thermally induced noise than an InGaAs detector. A Ge detector has a larger active area. The larger active area will lead, however, to a larger dark current as well as a lower shunt resistance. The smaller shunt resistance results in higher thermal noise. And the larger dark current results in higher shot noise. The dark current of Ge is already much higher than that of InGaAs, and the large active area can potentially introduce high noise current. The 2D tetralateral PSD 130 made of Ge can be designed to operate at wavelengths between about 600 nm and 1,700 m.

The embodiment of the optical detector system 100 illustrated in FIGS. 9 and 9A offers excellent performance for relatively large light spots 18 where position accuracy is required. It works well for both Gaussian and top-hat beams. In optics, a Gaussian beam is a beam of electromagnetic radiation with high monochromaticity whose amplitude envelope in the transverse plane is given by a Gaussian function; this also implies a Gaussian intensity (irradiance) profile. This fundamental transverse Gaussian mode describes the intended output of most (but not all) lasers, as such a beam can be focused into the most concentrated spot. A flat-top beam (or top-hat beam) is a light beam (often a transformed laser beam) having an intensity profile which is flat over most of the covered area. This is in contrast to Gaussian beams, where the intensity smoothly decays from its maximum on the beam axis to zero.

A back-illuminated sensor, also known as a backside illumination (BI) sensor, is a type of digital image sensor that uses a novel arrangement of the imaging elements to increase the amount of light captured and thereby improve low-light performance. A traditional, front-illuminated sensor is constructed in a fashion similar to the human eye, with a lens at the front and photodetectors at the back. This traditional orientation of the sensor places the active matrix of the sensor—a matrix of individual picture elements—on its front surface and simplifies manufacturing. The matrix and its wiring reflect some of the light, however, and thus the photoelectrode layer can only receive the remainder of the incoming light; the reflection reduces the signal that is available to be captured.

A back-illuminated sensor contains the same elements as the front-illuminated sensor, but arranges the wiring behind the photoelectrode layer by flipping the silicon wafer during manufacturing and then thinning its reverse side so that light can strike the photoelectrode layer without passing through the wiring layer. This change can improve the chance of an input photon being captured from about 60% to over 90%. The greatest difference is realized when pixel size is small, because the light capture area gained in moving the wiring from the top (light incident) to bottom surface is proportionately smaller for a larger pixel.

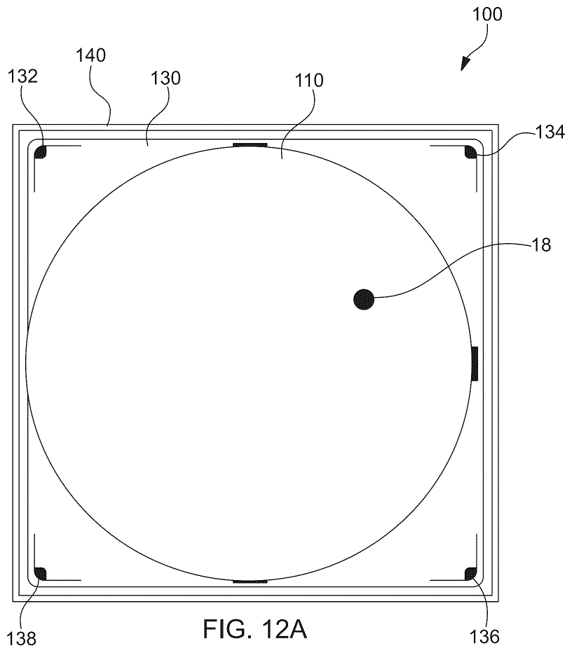

A back-illuminated embodiment of the optical detector system 100 is illustrated in FIG. 12 (side view) and FIG. 12A (top view). Like the front-illuminated embodiment of the optical detector system 100 illustrated in FIGS. 9 and 9A, the embodiment illustrated in FIGS. 12 and 12A has an apertured surface 102 with an aperture 104. The apertured surface 102 is affixed to one side of a transparent window 106. A space exists between the opposite side of the transparent window 106 and an optics layer (metastructure) 110. The metastructure 110 is affixed to the substrate 140 on the backside of the 2D tetralateral PSD 130. Thus, the 2D tetralateral PSD 130 is back-side illuminated in the embodiment of the optical detector system 100 illustrated in FIGS. 12 and 12A. The embodiment of the optical detector system 100 illustrated in FIGS. 12 and 12A offers excellent performance for relatively large and small light spots 18 where position accuracy is required. High resolution is achieved, which means 1 part in 10,000 position accuracy or better. Both embodiments work well for both Gaussian and top-hat beams.

The 2D tetralateral PSD 130 in each embodiment of the optical detector system 100 provides an output signal that is indicative of light incident upon its active area. For example, light incident on an active portion of the 2D tetralateral PSD 130 may produce an output current that is proportionate to the power of the incident light. The output signals may be processed by a computer system that includes a processor, database, and stored instructions to configure the processor to process data in accordance with the methods of the disclosure. An example computer system 200 is discussed below.

### C. The Hemispherical Metalens

A metalens is a type of flat, two-dimensional metasurface that manipulates light waves by controlling their phase distribution. Unlike conventional lenses, which rely on refraction and reflection, metalenses achieve wavefront shaping through nanoscale structures. These structures are composed of appropriately arranged nanoscale building blocks, allowing precise control over the phase of incident light. By doing so, metalenses can achieve desired reflected and transmitted waves based on Huygens' principle. The key advantage of metalenses lies in their flat, thin, lightweight, and compact design.

Metalenses (and more general metasurfaces) are increasingly seen as viable solutions for improving system performance while reducing system size and weight in complex imaging and illumination devices. This is because a single metalens can often be used to achieve the same performance that would otherwise require multiple “traditional” optical components within the device. A metalens employs a subwavelength “meta-atom” pattern on a dielectric surface to manipulate incident light. Specifically, the meta-atom pattern modifies the phase profile of the incident light beam, causing the beam to be bent (redirected). Meta optical structure are tiny, nanoscale structures with varying shapes and sizes whose position across the lens can be arbitrary and are designed to control the interaction of light. Although the “lens” part of the term “metalens” implies these components are used for focusing light like a traditional lens, the term has been adopted by the industry to cover a wide range of functionalities that phase manipulation affords.

To achieve this phase manipulation, metalenses require a large difference between the index of refraction of the meta optical structure and that of the surrounding material. The materials used for metalenses depend on the target wavelength range for the application of interest, in which material absorption is minimal and fabrication technologies can meet the feature size demands. For example, silicon is generally considered for near-infrared (IR) applications like LiDAR sensors, whereas titanium dioxide, gallium nitride, and silicon nitride are considered for camera applications in the visible wavelength range.

The method of fabrication will determine the possible meta-atom patterns that can be used in a metalens design. Known fabrication methods include e-beam lithography, DUV lithography, and nanoimprint lithography. E-beam lithography uses a focused beam of electrons to create nanoscale patterns on a base, offering exceptional precision and versatility in nanofabrication. This method is primarily for research applications, however, because it is not suitable for mass production of metalenses. DUV lithography uses deep ultraviolet (DUV) light to transfer intricate patterns onto a photosensitive material. This makes it a crucial technology in semiconductor manufacturing for high-resolution patterning. Nanoimprint lithography involves pressing a mold with predefined nanostructures onto a substrate. This provides a cost-effective and scalable method for replicating nanoscale patterns with high precision. Each of the three methods support flexible definitions of the meta-atom pattern in the X-Y plane of the surface, but they have limited ability to support variations in the Z direction. Therefore, many current metalens designs are based on binary shapes, in which the meta-atom pattern is uniform in the Z direction but arbitrary in the X-Y plane.

As illustrated in FIGS. 9, 9A, 12, and 12A and described above, the optical detector system 100 includes the metasurface 110. An embodiment of the metasurface 110 is illustrated in FIG. 13. The metasurface 110 comprises meta optical structure 112 fabricated or assembled on the base 114 to impart spatially varying optical phase delay and/or amplitude or polarization modulation onto a wavefront of incident light 120. The metasurface 110 is designed to create the annular light spot 18 incident on the 2D tetralateral PSD 130 of the optical detector system 100.

The glass elements which make up a traditional or ordinary lens can be thought of as cross-sections of a large sphere in which the curvature of each surface is even. The problem with spherical lens designs is that light passing through the outer edges of curved lenses focuses at different points from light passing through the center—creating a blur. This causes focus errors, or spherical aberration, and other forms of optical problems. Spherical lenses work fine if the recording surface is also spherical (e.g., the human eyeball), but in the case of photodetectors the surface is not spherical. Instead, the photodetector surface or chip surface is always substantially flat.

One way to fix the problem is to add additional lens elements to correct for the aberration. A generally more efficient way to address aberration is to make a lens element which is not a sphere in cross section. A hemispherical lens has a geometry consisting of a hemisphere of radius R on a cylinder of length L with the same radius. These lenses, also known as half-sphere lenses, provide an enhanced field of view. The curved shape of these lenses allows for a wider coverage area, capturing a larger portion of the surrounding environment. Hemispherical lenses are designed to collect light from a wide range of angles, making them highly efficient in capturing and focusing light onto a sensor or detector. Aberrations, such as spherical and chromatic aberrations, can significantly impact the quality of an optical system. Hemispherical lenses, with their curved shape and optimized design, help minimize these aberrations, resulting in sharper and more accurate images. Hemispherical lenses are typically compact and lightweight, making them easy to integrate into various optical systems. Their small form factor allows for flexibility in design and installation, making them suitable for applications where space is limited.

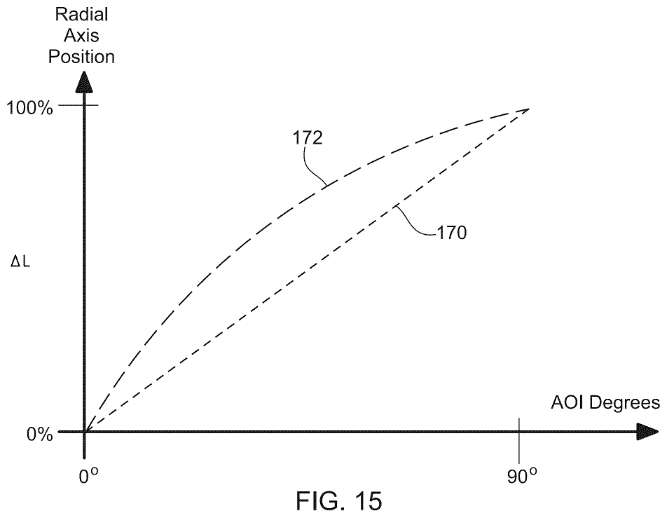

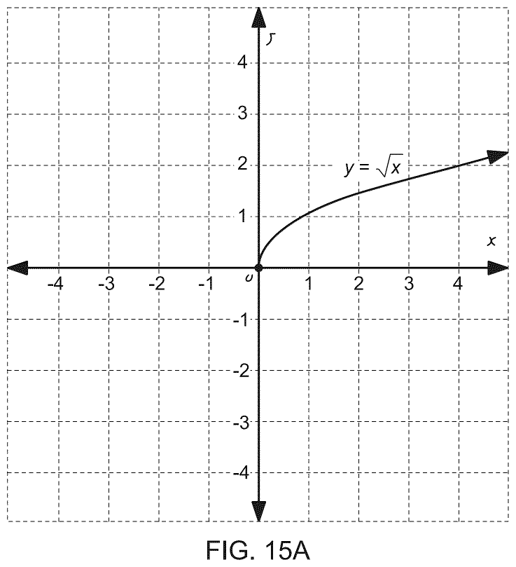

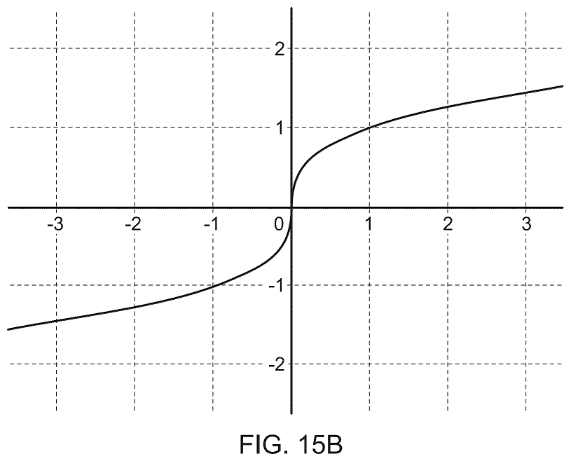

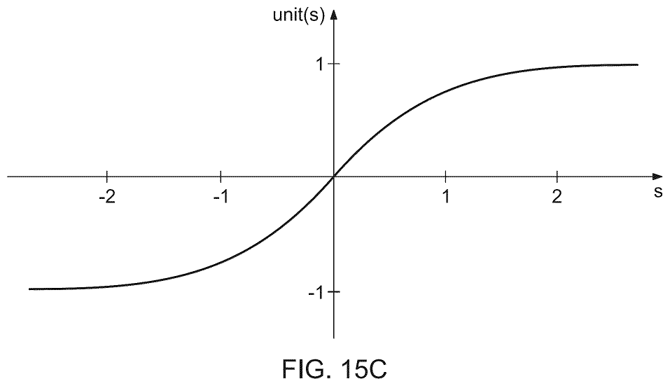

In some applications, it may be preferrable to design the hemispherical metalens 160 such that a nonlinear relationship, rather than a linear relationship, exists between the AOI and the radial axis position. FIGS. 15A, 15B, and 15C illustrate a square root function, a cube root function, and a hyperbolic tangent function, respectively. The curve 172 of FIG. 15 represents a square root relationship between the AOI and the radial axis position, i.e., the radial axis position (AL) is equal to the square root of the AOI. Additional curves could be generated and added to FIG. 15, of course, to represent a cube root or a hyperbolic tangent relationship between the AOI and the radial axis position.

As indicated above, the 2D tetralateral PSD 130 receives the fine beam light spot 18 and creates an X-Y position signal that is proportional to the photocurrents I₁, I₂, I₃, and I₄ in each of the four corner electrodes 132, 134, 136, and 138. When the 2D tetralateral PSD 130 is combined with the hemispherical metalens 160, corresponding azimuth and elevation angles can be determined from the X-Y position of the light spot 18 on the 2D tetralateral PSD 130. Azimuth and elevation are angular coordinates that define the direction of an object in a spherical coordinate system. Azimuth is the angle from the reference direction (usually north or the X axis) to the projection of the object on the reference plane (usually horizontal or the X-Y plane). Elevation is the angle from the reference plane to the object, where positive angles are oriented towards the zenith, or the point directly above the observer.

The speed at which the optical detector system 100, including the 2D tetralateral PSD 130 and the hemispherical metalens 160, can determine the azimuth and elevation angles of the incident light 120 is rapid (>2 Mhz). The optical detector system 100 permits the formation of a very small form factor photodetector device which will produce precise azimuth and elevation angle measurements within a hemisphere. Among the packaging systems in which the optical detector system 100 can be mounted to form a photodetector device are high-quality leadless chip carrier (LCC) packages and transistor-outline-can (TO-can) packages.

LLC packages are durable and are preferred where specifications require a low-profile package or a surface mountable, solderable package with low inductance to be used in various commercial applications. The TO-can package for optical components is an industry standard that governs the design and size of current-conducting microelectronic packaging and housings. Having been used for several decades, a TO package always consists of two components: a TO header and a TO cap. The TO header ensures that the encapsulated components are provided with power; the cap ensures the smooth transmission of optical signals.

There are many applications for which the packaging systems including the optical detector system 100 can be suitable. Among those applications are laser communications technologies that, for example, improve the efficiency of satellite communications. Another application is detection of laser designators. A laser designator is a laser light source which is used to designate a target. Laser designators provide targeting for laser-guided bombs, missiles, or precision artillery munitions. Yet another application is the study of measurement (metrology) such as in tip and tilt sensors and trilateration. Trilateration is the use of distances (or “ranges”) for determining the unknown position coordinates of a point of interest, often around Earth.

The optical detector system 100 could also be used as a component in a LiDAR system. An acronym for “light detection and ranging,” LiDAR is a remote-sensing technology that uses laser beams to measure precise distances and movement in an environment, in real time. LiDAR data can be used to generate everything from detailed topographic maps to the precise, dynamic 3D models that are required to safely guide an autonomous vehicle through a rapidly and constantly changing environment. LiDAR technology is also used to assess hazards and natural disasters such as lava flows, landslides, tsunamis, and floods.

### D. Testing of the Optical Detector System

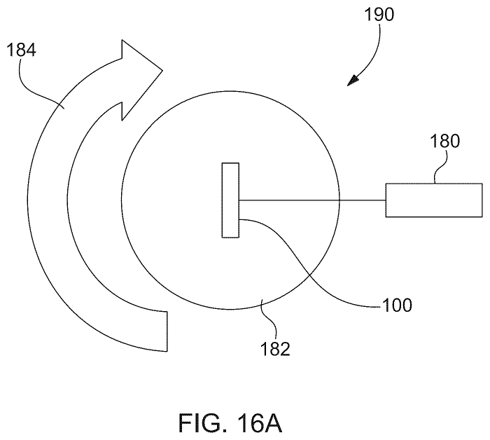

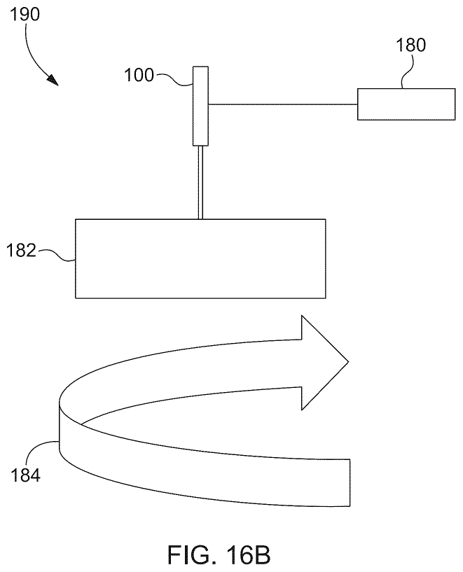

FIG. 16A is a top view and FIG. 16B is a side view of a test configuration 190 used for analysis and optimization of the optical detector system 100 according to the present disclosure. The incident light 120 emanated from a collimated laser 180 at a wavelength of 940 nm and was directed to the optical detector system 100 including a front-illuminated, 1 cm, 2D tetralateral PSD 130 formed of germanium and a linear hemispherical metalens 160. The back focal length of the hemispherical metalens 160 was about 2.4 mm (which provides a FOV of about 4 mm in diameter). The optical detector system 100 was mounted on a stage 182 able to rotate in a rotation direction 184 relative to the laser 180. As described below, the analysis of the optical detector system 100 using the test configuration 190 yielded good results.

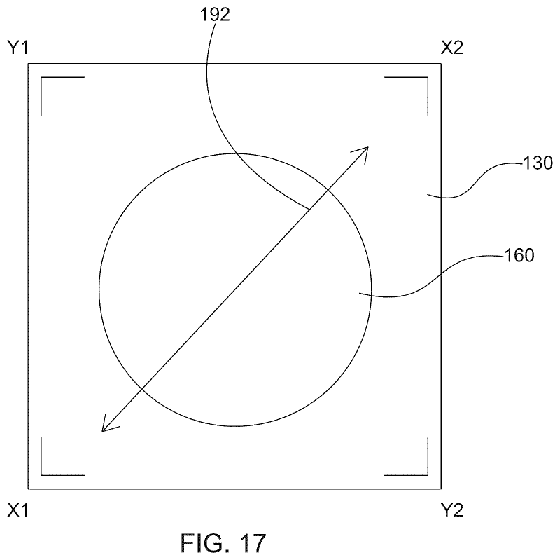

FIG. 17 illustrates the optical detector system 100 tested using the test configuration 190. The system 100 includes the 2D tetralateral PSD 130 on which is shown an image shadow of the metalens 160 (which includes the metasurface 110). Tests were conducted at an estimated 25 KHz bandwidth (−3 dB) at a load of about 50 ω. Voltage measurements were taken along the diagonal line 192 from one side (X1) to the other side (X2) of the 2D tetralateral PSD 130 (i.e., one degree of freedom).

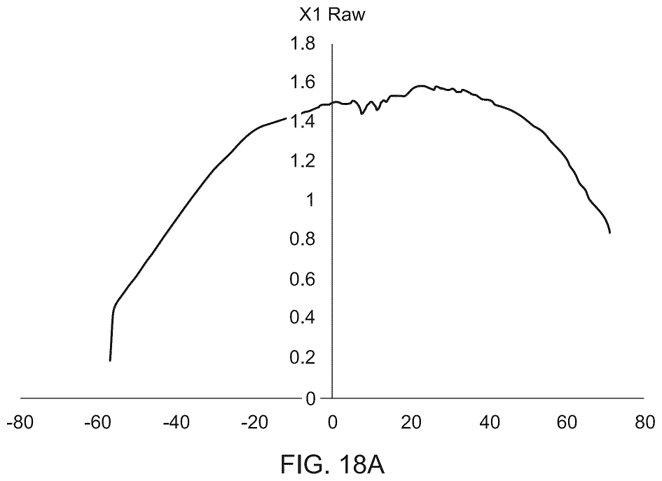

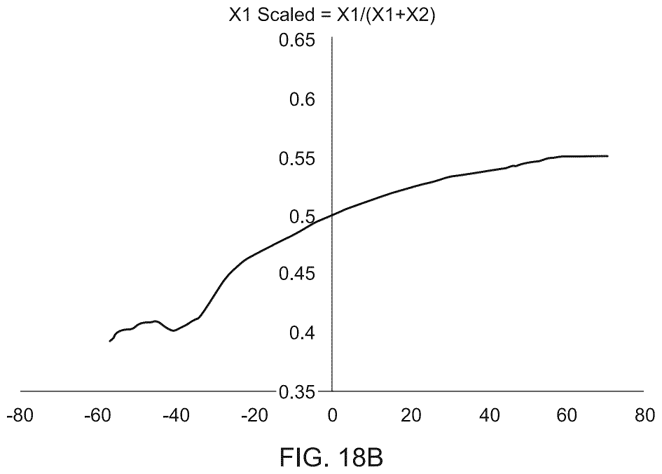

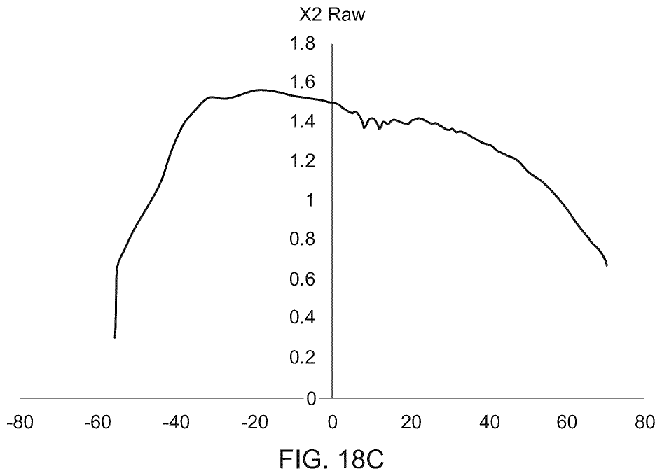

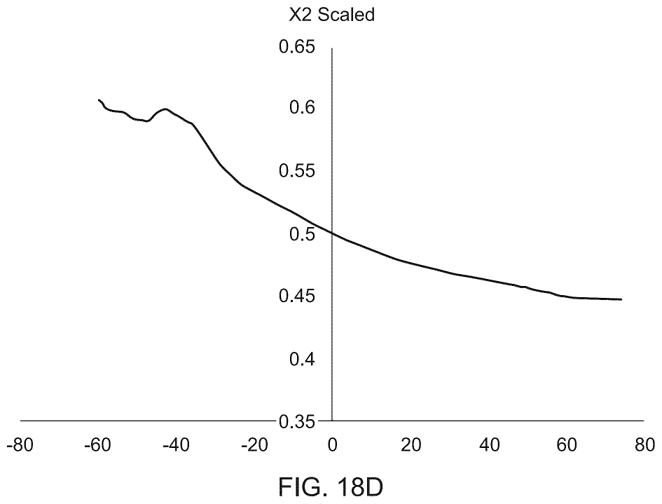

FIG. 18A is a graph of the photo-response in volts of the 2D tetralateral PSD 130 against the angle of the 2D tetralateral PSD 130 in degrees, reflecting raw X1 data. FIG. 18B is a corresponding graph reflecting scaled X1 data: X1 Scaled=X1/(X1+X2). Similarly, FIG. 18C is a graph of the photo-response in volts of the 2D tetralateral PSD 130 against the angle of the 2D tetralateral PSD 130 in degrees, reflecting raw X2 data. FIG. 18D is a corresponding graph reflecting scaled X2 data. The data of FIGS. 18B and 18D show substantially linear curves.

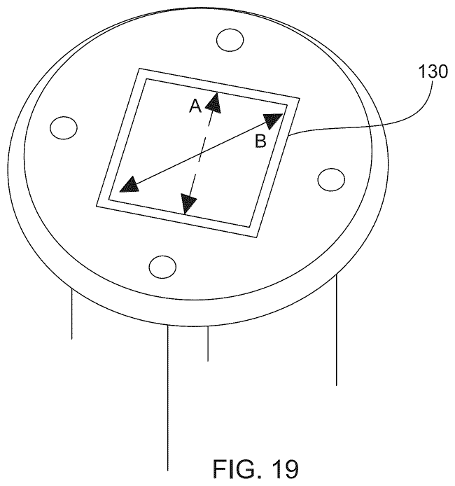

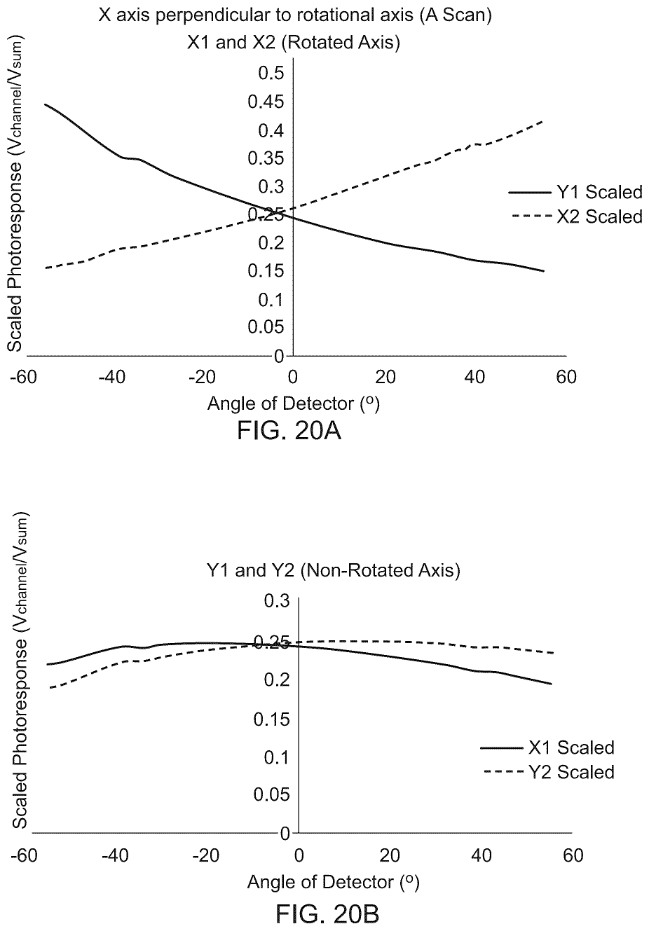

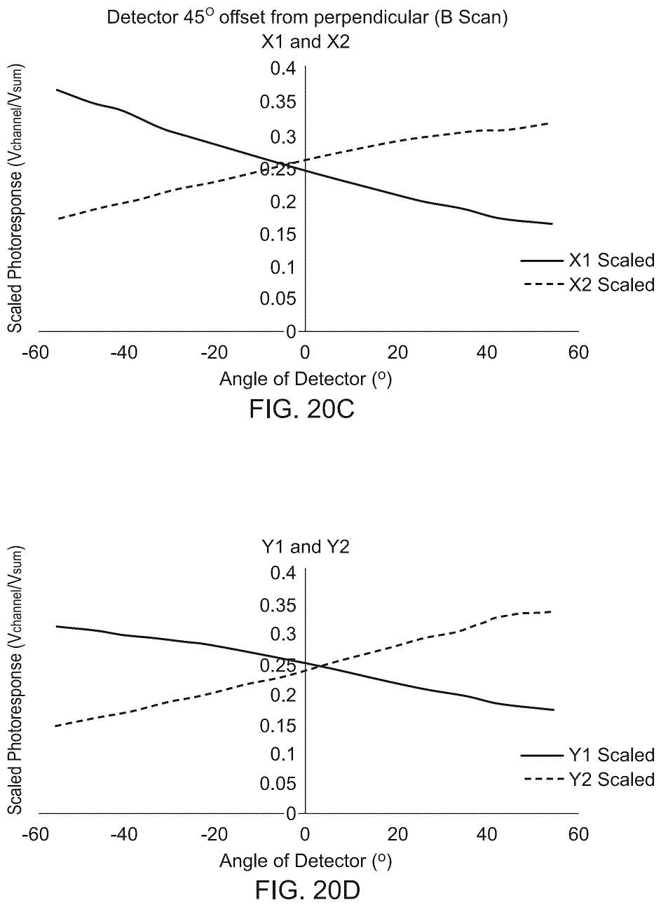

FIG. 19 shows the 2D tetralateral PSD 130 under test in which the power of the incident light 120 through the aperture 104 is about 10 mW. Measurements were taken along the X axis perpendicular to the rotation axis (“A” scan); these measurements are shown in FIGS. 20A and 20B. FIG. 20A is a graph of the scaled photo-response in volts (V_{Channel}/V_{Sum}) of the 2D tetralateral PSD 130 against the angle of the 2D tetralateral PSD 130 in degrees, reflecting both scaled Y1 data and scaled X2 data. FIG. 20B is a graph of the scaled photo-response in volts (V_{Channel}/V_{Sum}) of the 2D tetralateral PSD 130 against the angle of the 2D tetralateral PSD 130 in degrees, reflecting both scaled X1 data and scaled Y2 data.

Measurements were also taken along the diagonal of the 2D tetralateral PSD 130, i.e., along the 2D tetralateral PSD 130 at 45° offset from the perpendicular (“B” scan). These measurements are shown in FIGS. 20C and 20D. FIG. 20C is a graph of the scaled photo-response in volts (V_{Channel}/V_{Sum}) of the 2D tetralateral PSD 130 against the angle of the 2D tetralateral PSD 130 in degrees, reflecting both scaled X1 data and scaled X2 data. FIG. 20D is a graph of the scaled photo-response in volts (V_{Channel}/V_{Sum}) of the 2D tetralateral PSD 130 against the angle of the 2D tetralateral PSD 130 in degrees, reflecting both scaled Y1 data and scaled Y2 data. The data of FIGS. 20A, 20B, 20C, and 20D all show substantially linear curves across the range of data.

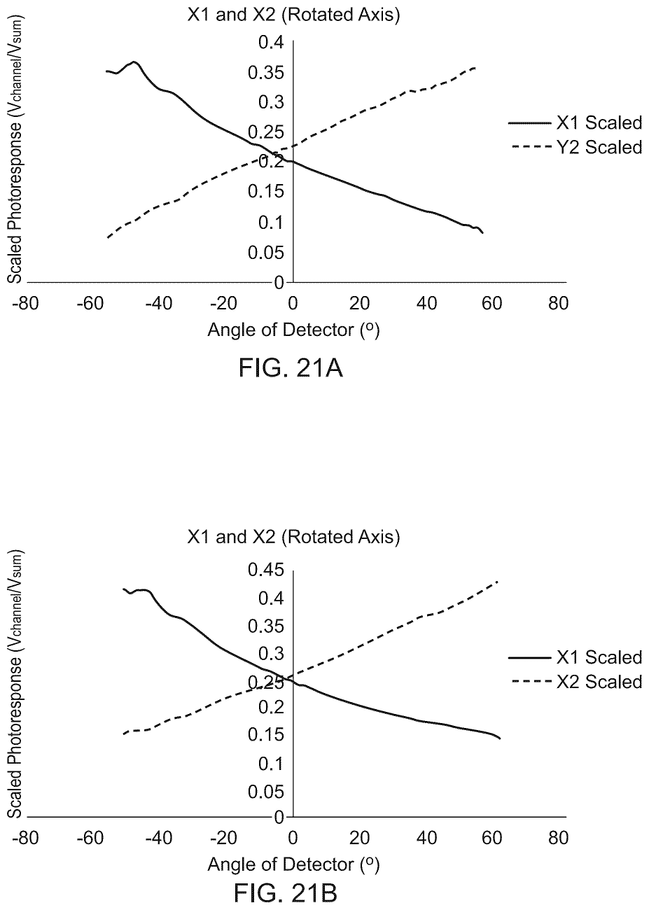

Tests were completed to ascertain whether the test results would vary with the power of the incident light 120 through the aperture 104. Measurements were taken along the X axis perpendicular to the rotation axis, i.e., the “A” scan shown in FIG. 19. FIG. 21A is a graph of the scaled photo-response in volts (V_{Channel}/V_{Sum}) of the 2D tetralateral PSD 130 against the angle of the 2D tetralateral PSD 130 in degrees, reflecting both scaled X1 data and scaled X2 data, at a power of about 570 μW. FIG. 21B is a graph of the scaled photo-response in volts (V_{Channel}/V_{Sum}) of the 2D tetralateral PSD 130 against the angle of the 2D tetralateral PSD 130 in degrees, reflecting both scaled X1 data and scaled X2 data, at a power of about 10 mW. The data show little impact of the change in power.

### E. The Cooling Mechanism

Thermal management is an important consideration in the operation of the 2D tetralateral PSD 130 described herein. Under conditions of sustained or high-intensity illumination, the 2D tetralateral PSD 130 may experience thermal accumulation, which can adversely affect its positional sensitivity, introduce noise, or degrade the overall response uniformity of the sensor. As such, the optical detector system 100 disclosed herein may further include one or more cooling mechanisms adapted to maintain the 2D tetralateral PSD 130 within its optimal temperature range during operation. Additionally, cooling the 2D tetralateral PSD 130 well below ambient can greatly reduce the dark current (optical noise floor) so that weaker light rays exiting from the meta surface can also be detected without degradation in device performance.

The cooling mechanisms may be implemented to operate in either passive or active modes and may include closed-loop control elements. The purpose of these mechanisms is to extract heat generated within or conducted to the 2D tetralateral PSD 130 and its supporting substrate, thereby stabilizing the detector's thermal environment. Temperature regulation in this context improves the accuracy, response time, and reliability of the output signal produced by the 2D tetralateral PSD 130, particularly under variable or extreme environmental conditions.

The cooling mechanisms described above may be positioned in various locations relative to the 2D tetralateral PSD 130 depending on the specific design of the optical detector system 100 and thermal management requirements. In one configuration, the cooling system may be mounted below the 2D tetralateral PSD 130, in direct thermal contact with the detector's substrate or support structure, allowing for efficient conduction of heat away from the active area. Alternatively, where space and optical path design permit, the cooling mechanism may be positioned above the 2D tetralateral PSD 130, adjacent to or integrated within the metasurface or transparent window assembly, provided such placement does not interfere with the transmission of incident light. In still other embodiments, lateral placement of cooling elements around the perimeter of the 2D tetralateral PSD 130 may be used, particularly in compact, hermetically sealed packages. In back-illuminated detector configurations, cooling elements may also be thermally bonded to the rear surface of the 2D tetralateral PSD 130 to optimize heat extraction without impeding the optical aperture. These options allow for flexible integration of thermal regulation features into a wide range of package geometries and operating environments.

In one embodiment, the optical detector system 100 includes a closed-loop thermoelectric cooler (TEC) thermally coupled to the substrate upon which the 2D tetralateral PSD 130 is mounted. The TEC may be driven by a controller circuit that receives input from one or more thermal sensors positioned near or on the 2D tetralateral PSD 130. The TEC, operating via the Peltier effect, actively transfers heat from the PSD toward a remote heatsink or thermal dissipative structure. By adjusting the electrical input to the TEC based on feedback from the thermal sensors, the closed-loop configuration allows precise temperature regulation.

In another embodiment, the optical detector system 100 may include a closed-loop fluid-based cooling system, in which a dielectric coolant circulates through microchannels or tubing in thermal contact with the 2D tetralateral PSD's 130 mounting substrate. A pump moves the fluid through the system, and temperature sensors provide feedback to a controller that regulates flow rate and fluid temperature. Heat extracted from the detector assembly may be dissipated through an external radiator or heat exchanger, enabling the 2D tetralateral PSD to operate stably in high-power applications.

In yet another embodiment, the optical detector system 100 may be integrated with a closed-loop radiative cooling system. Here, a thermally conductive radiative plate or fin structure is thermally coupled to the 2D tetralateral PSD substrate and is configured to emit infrared radiation into the surrounding environment. In vacuum or spaceborne applications, this radiation-based dissipation is enhanced. A thermal feedback circuit can adjust the emissivity of the radiative surface, for example by modulating a variable-emissivity coating or a surface-aligned electrochromic layer.

A further embodiment includes a passive heat sink arrangement, wherein the 2D tetralateral PSD substrate is bonded to a high-thermal-conductivity structure, such as a copper or aluminum heat sink, optionally coupled with a thermal interface material. This configuration may be sufficient in low-power or pulsed-operation scenarios, where peak thermal loads are modest.

Any of the cooling mechanisms described herein may be employed individually or in combination, and may be integrated into the compact electro-optic package containing the metalens and 2D tetralateral PSD. These thermal management solutions ensure that the detector performance remains consistent across varying environmental conditions and during extended operational periods.

### F. The Computer System

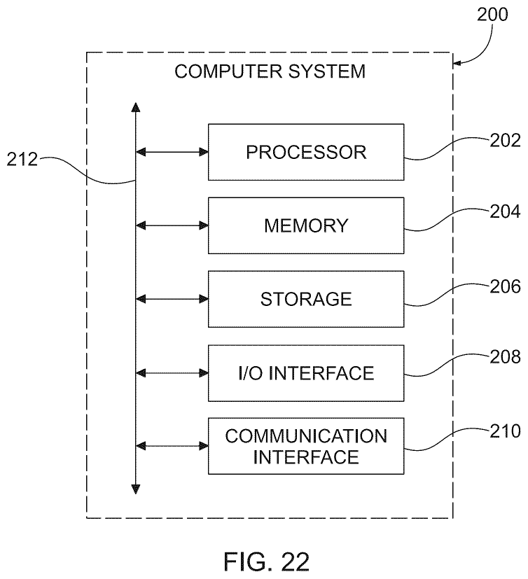

FIG. 22 illustrates an example computer system 200 which can be included in, or at least operate in connection with, the optical detector system 100. In particular embodiments, one or more computer systems 200 engage with one or more components, and perform one or more steps of one or more methods, described or illustrated in this document. In particular embodiments, one or more computer systems 200 provide functionality described or illustrated in this document. In particular embodiments, software running on one or more computer systems 200 performs one or more steps of one or more methods described or illustrated in this document or provides functionality described or illustrated in this document. Particular embodiments include one or more portions of one or more computer systems 200. In this document, reference to a computer system may encompass a computing device, and vice versa, where appropriate. Moreover, reference to a computer system may encompass one or more computer systems, where appropriate.

This disclosure contemplates any suitable number of computer systems 200. This disclosure contemplates the computer system 200 taking any suitable physical form. As example and not by way of limitation, the computer system 200 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these devices. Where appropriate, the computer system 200 may include one or more computer systems 200; be unitary or distributed; span multiple locations; span multiple machines; span multiple data centers; or reside in a cloud, which may include one or more cloud components in one or more networks. Where appropriate, one or more computer systems 200 may perform without substantial spatial or temporal limitation one or more steps of one or more methods described or illustrated in this document. As an example and not by way of limitation, the one or more computer systems 200 may perform in real time or in batch mode one or more steps of one or more methods described or illustrated in this document. The one or more computer systems 200 may perform at different times or at different locations one or more steps of one or more methods described or illustrated in this document, where appropriate.

In particular embodiments, the computer system 200 includes a processor 202, memory 204, storage 206, an input/output (I/O) interface 208, a communication interface 210, and a bus 212. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 202 includes hardware for executing instructions, such as those making up a computer program. As an example and not by way of limitation, to execute instructions, the processor 202 may retrieve (or fetch) the instructions from an internal register, an internal cache, the memory 204, or the storage 206; decode and execute them; and then write one or more results to an internal register, an internal cache, the memory 204, or the storage 206. In particular embodiments, the processor 202 may include one or more internal caches for data, instructions, or addresses. This disclosure contemplates the processor 202 including any suitable number of any suitable internal caches, where appropriate. As an example and not by way of limitation, the processor 202 may include one or more instruction caches, one or more data caches, and one or more translation lookaside buffers (TLBs). Instructions in the instruction caches may be copies of instructions in the memory 204 or the storage 206, and the instruction caches may speed up retrieval of those instructions by the processor 202. Data in the data caches may be copies of data in the memory 204 or the storage 206 for instructions executing at the processor 202 to operate on; the results of previous instructions executed at the processor 202 for access by subsequent instructions executing at the processor 202 or for writing to the memory 204 or the storage 206; or other suitable data. The data caches may speed up read or write operations by the processor 202. The TLBs may speed up virtual-address translation for the processor 202. In particular embodiments, the processor 202 may include one or more internal registers for data, instructions, or addresses. This disclosure contemplates the processor 202 including any suitable number of any suitable internal registers, where appropriate. Where appropriate, the processor 202 may include one or more arithmetic logic units (ALUs); be a multi-core processor; or include one or more processors 202. Although this disclosure describes and illustrates a particular processor, this disclosure contemplates any suitable processor.

In particular embodiments, the memory 204 includes main memory for storing instructions for the processor 202 to execute or data for the processor 202 to operate on. As an example and not by way of limitation, the computer system 200 may load instructions from the storage 206 or another source (such as, for example, another computer system 200) to the memory 204. The processor 202 may then load the instructions from the memory 204 to an internal register or internal cache. To execute the instructions, the processor 202 may retrieve the instructions from the internal register or internal cache and decode them. During or after execution of the instructions, the processor 202 may write one or more results (which may be intermediate or final results) to the internal register or internal cache. The processor 202 may then write one or more of those results to the memory 204. In particular embodiments, the processor 202 executes only instructions in one or more internal registers or internal caches or in the memory 204 (as opposed to the storage 206 or elsewhere) and operates only on data in one or more internal registers or internal caches or in the memory 204 (as opposed to the storage 206 or elsewhere). One or more memory buses (which may each include an address bus and a data bus) may couple the processor 202 to the memory 204. The bus 212 may include one or more memory buses, as described below. In particular embodiments, one or more memory management units (MMUs) reside between the processor 202 and the memory 204 and facilitate accesses to the memory 204 requested by the processor 202. In particular embodiments, the memory 204 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. The memory 204 may include one or more memories 204, where appropriate. Although this disclosure describes and illustrates particular memory, this disclosure contemplates any suitable memory.

In particular embodiments, the storage 206 includes mass storage for data or instructions. As an example and not by way of limitation, the storage 206 may include a hard disk drive (HDD), a floppy disk drive, flash memory, an optical disc, a magneto-optical disc, magnetic tape, or a Universal Serial Bus (USB) drive or a combination of two or more of these. The storage 206 may include removable or non-removable (or fixed) media, where appropriate. The storage 206 may be internal or external to the computer system 200, where appropriate. In particular embodiments, the storage 206 is non-volatile, solid-state memory. In particular embodiments, the storage 206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates the storage 206 taking any suitable physical form. The storage 206 may include one or more storage control units facilitating communication between the processor 202 and the storage 206, where appropriate. Where appropriate, the storage 206 may include one or more storages 206. Although this disclosure describes and illustrates particular storage, this disclosure contemplates any suitable storage.

In particular embodiments, the I/O interface 208 includes hardware, software, or both, providing one or more interfaces for communication between the computer system 200 and one or more I/O devices. The computer system 200 may include one or more of these I/O devices, where appropriate. One or more of these I/O devices may enable communication between a person and the computer system 200. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 208 for them. Where appropriate, the I/O interface 208 may include one or more device or software drivers enabling the processor 202 to drive one or more of these I/O devices. The I/O interface 208 may include one or more I/O interfaces 208, where appropriate. Although this disclosure describes and illustrates a particular I/O interface, this disclosure contemplates any suitable I/O interface.

In particular embodiments, the communication interface 210 includes hardware, software, or both providing one or more interfaces for communication (such as, for example, packet-based communication) between the computer system 200 and one or more other computer systems 200 or one or more networks. As an example and not by way of limitation, the communication interface 210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 210 for it. As an example and not by way of limitation, the computer system 200 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computer system 200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. The computer system 200 may include any suitable communication interface 210 for any of these networks, where appropriate. The communication interface 210 may include one or more communication interfaces 210, where appropriate. Although this disclosure describes and illustrates a particular communication interface, this disclosure contemplates any suitable communication interface.

In particular embodiments, the bus 212 includes hardware, software, or both coupling components of the computer system 200 to each other. As an example and not by way of limitation, the bus 212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. The bus 212 may include one or more buses 212, where appropriate. Although this disclosure describes and illustrates a particular bus, this disclosure contemplates any suitable bus or interconnect.

In this document, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of the processor 202 (such as, for example, one or more internal registers or caches), one or more portions of the memory 204, one or more portions of the storage 206, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. In this document, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in C++, C#, Python, Java, JavaScript, Solidity, Vyper, Golang, Simplicity, or Rholang. In particular embodiments, software is expressed in Hyper Text Markup Language (HTML), Extensible Markup Language (XML), JavaScript Object Notation (JSON) or other suitable markup language.

Although illustrated and described above with reference to certain specific embodiments and examples, the present disclosure is nevertheless not intended to be limited to the details shown. Rather, various modifications may be made in the details within the scope and range of equivalents of the claims and without departing from the spirit of the disclosure.

What is claimed:

1. An optical detector system receiving incident light ray having azimuth and elevation angles at different angles of incidence, the system comprising:
an apertured surface having an aperture through which pass the incident light rays;
a transparent window having a first side to which the apertured surface is affixed and an opposite side, the incident light rays passing through the window;
a metasurface disposed on the opposite side of the window and including a meta optical surface assembled on a base to impart spatially varying optical phase delay and/or amplitude or polarization modulation onto the incident light rays, the metasurface turning each incident light ray a different amount depending upon the angle of incidence of the incident light ray and creating exiting light rays that are displace depending on angle of incidence of light ray entering aperture; and
light rays from the meta optical surface which are received by a two-dimensional tetralateral position sensing detector having a single resistive layer and four separate electrodes, the tetralateral position sensing detector receiving the exiting light rays from the metasurface and generating an X-Y position signal.

2. The optical detector system according to claim 1 wherein the incident light ray has a wavelength from 300 nm to 2.6 μm.

3. The optical detector system according to claim 1 wherein the incident light ray has an optical linewidth greater than 3 nm full width half max.

4. The optical detector system according to claim 1 wherein the incident light ray has an optical linewidth less than 3 nm full width half max.

5. The optical detector system according to claim 1 wherein the angles of incidence for both the azimuth and elevation acceptance angle of ≤=170 degrees.

6. The optical detector system according to claim 1 wherein the optical detector system has a electro optical bandwidth less than 10 Mhz.

7. The optical detector system according to claim 1 wherein the power of light ray entering aperture is greater than 1 μW.

8. An optical detector system receiving incident light ray having azimuth and elevation angles at different angles of incidence, the system comprising:
an apertured surface having an aperture through which pass the incident light rays;
a transparent window having a first side to which the apertured surface is affixed and an opposite side, the incident light rays passing through the window;
a metasurface disposed on the opposite side of the window and including a meta optical surface assembled on a base to impart spatially varying optical phase delay and/or amplitude or polarization modulation onto the incident light rays, the metasurface turning each incident light ray a different amount depending upon the angle of incidence of the incident light ray and creating exiting light rays that are displace depending on angle of incidence of light ray entering aperture; and
light rays from the meta optical surface which are received by a two-dimensional tetralateral position sensing detector adapted to be cooled by a cooling mechanism and having a single resistive layer and four separate electrodes, the tetralateral position sensing detector receiving the exiting light rays from the metasurface and generating an X-Y position signal.

9. The optical detector system according to claim 8 wherein the integrated in device or external to device package cooling mechanism comprises a closed loop thermo electric cooler, a closed loop radiative or fluid cooler, or combination thereof.

10. The optical detector system according to claim 9 wherein the incident light ray has a wavelength from 300 nm to 2.6 The optical detector system according to claim 9 wherein the optical linewidth less than 3 nm full width half. The optical detector system according to claim 9 wherein the optical linewidth less than 3 nm full width half. max. The optical detector system according to claim 9 wherein the angles of incidence for both the azimuth and elevation acceptance angle of less than 170 degrees.

11. The optical detector system according to claim 9 wherein the optical detector system has a electro optical bandwidth less than 10 Mhz.

12. The optical detector system according to claim 9 wherein the power of light ray entering aperture is less than 100 mW.

13. An optical detector system receiving incident light ray having azimuth and elevation angles at different angles of incidence, the system comprising:
an apertured surface having an aperture through which pass the incident light rays;
a transparent window having a first side to which the apertured surface is affixed and an opposite side, the incident light rays passing through the window;
a metasurface disposed on the opposite side of the window and including a meta optical surface assembled on a base to impart spatially varying optical phase delay and/or amplitude or polarization modulation onto the incident light rays, the metasurface turning each incident light ray a different amount depending upon the angle of incidence of the incident light ray and creating exiting light rays that are displace depending on angle of incidence of light ray entering aperture;
light rays from the meta optical surface which are received by a two-dimensional tetralateral position sensing detector adapted to be cooled by a cooling mechanism, wherein the cooling mechanism comprises a closed loop thermo electric cooler, a closed loop radiative cooler, or combination thereof, and having a single resistive layer and four separate electrodes, the tetralateral position sensing detector receiving the exiting light rays from the metasurface and generating an X-Y position signal; and
a computer configured to determine, based on the X-Y position signal generated by the tetralateral position sensing detector, the azimuth and elevation angles of the incident light rays.

14. The optical detector system according to claim 13 wherein the incident light ray has a wavelength from 300 nm to 2.6 μm.

15. The optical detector system according to claim 13 wherein the incident light ray has a optical linewidth greater than 3 nm full width half max.

16. The optical detector system according to claim 13 wherein the incident light ray has a optical linewidth h less than 3 nm full width half max.

17. The optical detector system according to claim 13 wherein the optical detector system has a electro optical bandwidth less than 10 Mhz.
